(19) United States
(12) Patent Application Publication
(10) Pub. No.: US 2021/0310848 A1
(43) Pub. Date: Oct. 7, 2021

(54) CLOSED TANK FILL LEVEL SENSOR

(71) Applicant: Independent Technologies, LLC, Blair, NE (US)

(72) Inventors: Jeffrey O. Smith, Dallas, TX (US); Rodney C. Montrose, Allen, TX (US); Stephen Barth, Fort Worth, TX (US)

(21) Appl. No.: 17/349,551

(22) Filed: Jun. 16, 2021

Related U.S. Application Data
(63) Continuation of application No. 14/872,997, filed on Oct. 1, 2015, now abandoned.

(51) Int. Cl. G01F 23/14; G01F 25/00; G01F 23/00; G01F 23/18

(52) U.S. Cl. CPC G01F 23/14; G01F 23/18; G01F 23/0061; G01F 25/0061

(57) ABSTRACT

A fill level sensor and method are disclosed. The fill level sensor can take a pressure reading beneath a fluid level inside a closed tank. The sensor can also take a pressure reading above the field level or otherwise take the vapor pressure above the fluid info account. The measurements can be used to calculate the fluid level inside the tank. Also disclosed is a system for users to track a plurality of tanks and maintain records of fluid level or pressure within the tanks.

### TECHNICAL FIELD

The present disclosure is directed to the transport of liquids within tunics, and more particularly to pressure sensors for the liquids and tanks.

### BACKGROUND OF THE INVENTION

Various types of liquids are stored and transported in tanks. These tanks can be stored in warehouses or factories, or attached to trucks, boats, planes and other vehicles. Common liquids stored in tanks can be water, oil, and other substances. It can be important to monitor various properties or conditions of the liquid or container. For example, a pressure monitor may be needed to ensure that pressure is not too high or too low depending on die desired state of the liquid and container. A liquid's properties may change at various temperatures and pressures. The entity storing or transporting a liquid may need to track its temperature, pressure or other properties and may want to adjust these properties if possible. The fill level within a tank or container may also need to be monitored.

A related problem is that in a tank that is storing or transporting a liquid, there will likely be vapor within the tank because the liquid does not completely fill the tank. The pressure of the vapor can distort readings of the liquid's pressure. There are needed tools and processes for accurately measuring the pressure of the vapor and/or liquid.

Pressure sensors can also be used to measure a fill level within a tank. By measuring the pressure at a point below the fluid level, a user can calculate the fluid level within a container. Such calculations are based on the atmospheric pressure. Problems can arise when a fluid level sensor is within an enclosed container or tank. The enclosure can isolate the fluid horn the effects of atmospheric pressure. The calculation to convert a measured pressure into a fluid level must therefore be adjusted.

### BRIEF SUMMARY OF THE INVENTION

One embodiment of the disclosure comprises a tank fill level sensor comprising a pressure sensor located near the bottom of a tank and comprising a first connection to the outside atmosphere; a calibration sensor located near the top of the tank and comprising a second connection to the outside atmosphere; and a processor connected to the pressure sensor and the calibration sensor and operable to obtain a pressure level from each sensor and thereby calculate a fill level within the tank.

Another embodiment comprises a tank fill level sensor comprising a housing, the housing comprising a pressure sensor located near the bottom of a tank, the housing further comprising an inlet near the top oi the tank, the housing further comprising an output, the output extending outside of the tank and operable to provide pressure measurements to a processor.

Another embodiment comprises a system for monitoring containers comprising: a plurality of containers, each of the plurality of containers comprising a fill level sensor in its interior, the till level sensors comprising a pressure sensor located near the bottom of the container and an inlet near die top of the container, an output of the fill level sensor in communication with a radio interface operable to communicate measurements front the fill level sensors; and a plurality of servers operable to receive communications from the plurality of fill level sensors and store the status of each of the plurality of fill level sensors.

Another embodiment comprises a method for measuring the fill level in a closed container comprising: receiving a first pressure reading from the top half of the closed container; receiving a second pressure reading from the bottom halt of the closed container; using the first and second pressure readings to determine a fill level of liquid within the closed container.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized an a basis for modifying or designing other structures for carrying out the same purposes of the present invention, li should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of die present invention, reference is now made to the following descriptions taken in conjunction with the accompanying drawings, in which:

FIG. 1 is a diagram of a prior art system.

FIG. 2 is a diagram of an embodiment of the present disclosure.

FIG. 3 is a diagram of an embodiment of the present disclosure.

FIG. 4 is a flowchart diagram of a process embodiment of the present disclosure.

FIG. 5 is a diagram of a embodiment of a system according to the present disclosure.

### DETAILED DESCRIPTION OF THE INVENTION

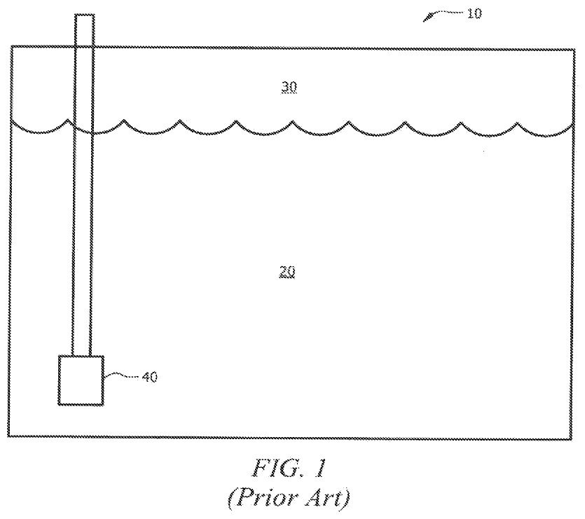

Referring now to FIG. 1, an embodiment of the prior art is shown. FIG. 1 shows a tank 10 with a liquid 20 and vapor 30. Pressure sensor 40 is disposed below the liquid level and can measure the pressure of the liquid 20. Sensor 40 is attached to a tube that extends outside of the tank in order to compare the pressure measure in the tank 10 to the pressure ex tenor to the tank. In this setup the pressure sensor 40 is connected by an open tube to the outside atmosphere. However, the pressure difference between vapor 30 and the outside atmosphere can cause misreading at pressure sensor 40. If the pressure reading at 40 is distorted then any calculation of fluid level (based on pressure) will be incorrect.

The pressure measurements within the tank can be used to measure the level of the fluid. Under atmospheric pressure, the pressure measured at a sensor under a fluid follows the equation P=μgh (P=pressure, ρ=density of the fluid, g=standard gravity, and h=height of fluid column above the pressure sensor). Therefore, in many situations, measuring a pressure can allow a user to calculate the fluid level within the tank. When measuring fluid levels within an enclosed tank however, the liquid is set off from the surrounding atmospheric pressure and the values of ρ, g, and h may be effected. The above equation would need to be altered to account for these changes. For this reason, the present disclosure can provide more reliable measurements because the effect of the vapor pressure within the tank is taken into consideration.

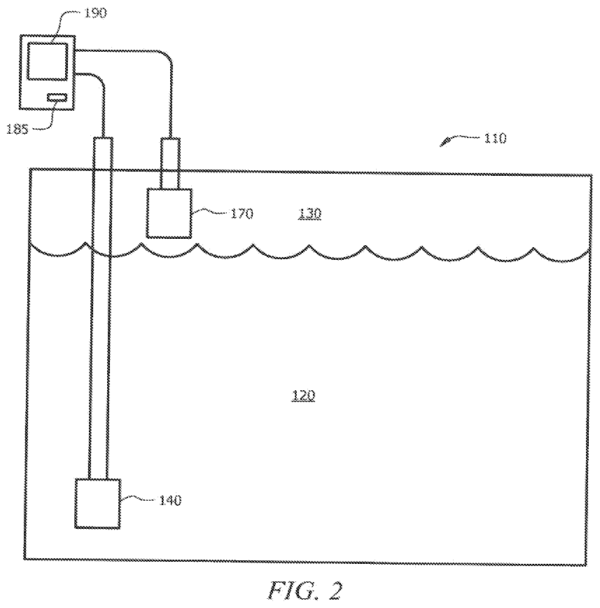

In FIG. 2 an embodiment of the teachings in the present disclosure can be seen. In FIG. 2 a tank 110 contains liquid 120 and vapor 130. Pressure sensor 140 is mounted in the tank 110 to measure the pressure at a certain point in the tank below the fluid level. Calibration sensor 170 is placed in the tank 110 above the liquid level and measures the vapor pressure in the tank 110. The pressure readings at 140 and 170 can be used to calculate a fluid level within the tank. Sensors 140 and 170 can connect to a processor 185 and display 190. The processor 185 can use the sensor readings and display the readings by means of display 190. Processor 185 can also use the sensor readings to calculate die fluid level and display the level on display 190. Processor 185 and display 190 can be mounted to the side of the tank 110 or otherwise networked with sensors 140 and 170.

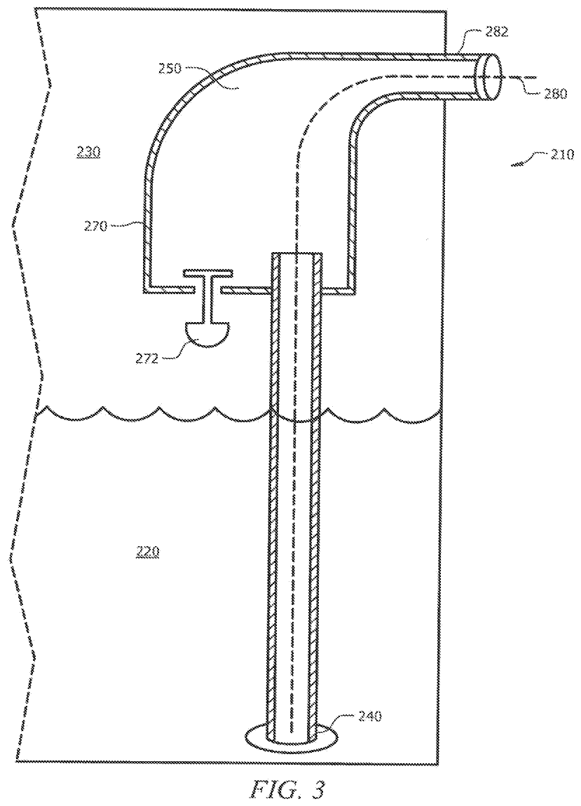

FIG. 3 shows another embodiment illustrating the teachings of the disclosure. Tank 210 contains liquid 220 and vapor 230. Fill level sensor 250, has an open tube that terminates inside of the tank instead of outside. Fill level sensor 250 is terminated inside the tank 210 in a housing that allows the sensor to “sec” the vapor pressure of the tank 210 and thus accurately read the pressure at sensor 240. Pressure sensor 240 detects the pressure beneath the liquid level while calibration sensor 270 allows the vapor pressure to calibrate pressure sensor 240. Output 280 can connect to a processor, display, radio interface or other device. Plug 272 can prevent liquid from entering the housing and entering the open tube of the pressure device 250. Seal 282 prevents vapor from escaping and also prevents the sensor 240 front sensing the outside ambient pressure.

The output 280 of FIG. 3, or outputs from sensors 140, 170 in FIG. 2 can connect to a processor, computer, or other device to read the measured data, or to calculate other data such as the fluid level. Preferably the outputs connect to a processor and a display to allow users to read a pressure reading or fluid level. Displays could include a computer screen, a handheld-sized display or another type of display A display could use plasma, LED, LCD, or a variety of other technologies. The outputs could connect directly to a processor and display, or they could connect to a wireless transmitter such as Wi-Fi or Bluetooth which would then transmit information locally (or globally) for display on another device, such as a smartphone, tablet or other device. The display and/or processor may be mounted or integrated onto the side of a tank. Alternatively, numerous tank in one location can be networked together (wireless or hardwire) and may share a processor and/or display. The processor can be integrated into a computer or servers with powerful processing capabilities or alternatively the processor may be much simpler, only converting pressure readings info fluid levels and controlling a simple monochrome display.

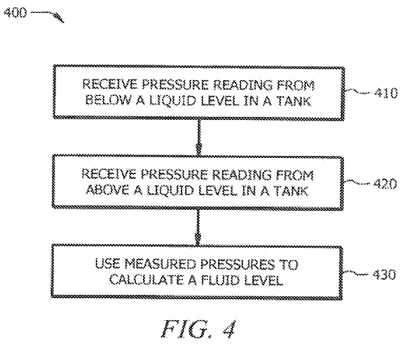

FIG. 4 displays an embodiment of a method of practicing some of the teachings disclosed herein. At a first step 410, a pressure reading is received from below a liquid level in a tank. At a next step 420, a pressure reading is received from above a liquid level in a tank. Finally, the pressure readings are used to obtain a fluid level within the tank 430. The first two steps of this method can be performed in reverse order.

In a preferred embodiment, the present teachings can be used tor monitoring stationary tanks, which can be located at warehouses, worksites, industrial locations, or other locations. Alternatively, the teachings can be used to monitor tanks and containers during transport.

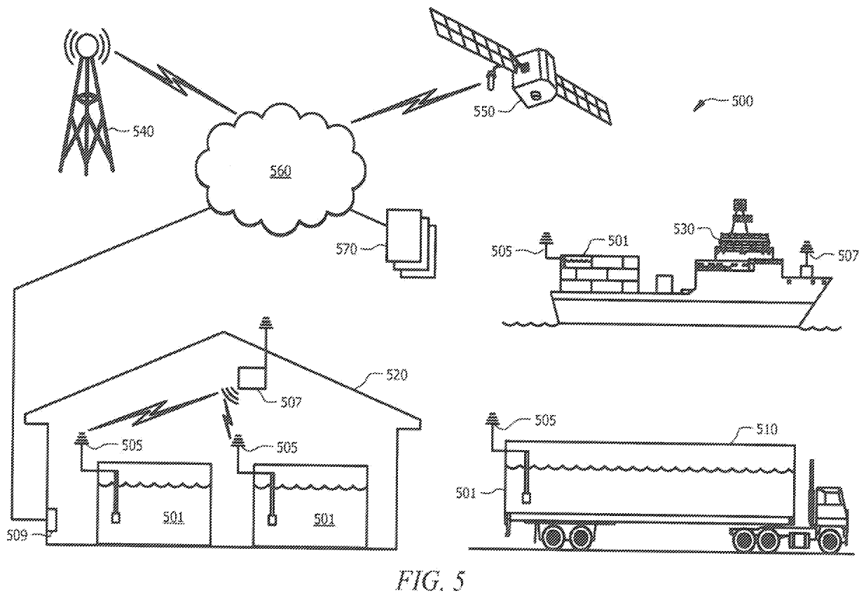

FIG. 5 shows an embodiment of a system implementing the teachings of the present disclosure. As shown, fill level sensors 505 are integrated into a variety of tanks 501; in a warehouse 520, on a truck 510, and on a boat 530. Sensors 505 comprise a communications interface that can communicate with a telecommunications network such as cellular network 540, satellite network 550, or another network. In some embodiments, sensors 505 communicate with a communications hub 507, possibly by Wi-Fi or Bluetooth, that can then communicate with networks such as cellular network 540, satellite network. 550, or another network. Also possible is a hardline connection 509, shown on warehouse 520. Whatever telecommunications network is used, communications can go through a network 560, such as the Internet, and to servers 570. Servers 570 can store and monitor conditions of a plurality of tanks. Servers 570 can comprise a variety and plurality of computers, servers and other devices. System 500 can be used by a company to track materials/tanks that it is storing or transporting. The company can track location if each device 505 comprises a GPS or other location determination device. Furthermore, the company can track the fill levels of its various tanks, the pressures within the tanks, or other properties. A company could thereby assess dangerous or suboptimal storage or transportation methods, or even determine if substances are being stolen. The system could ho used to provide various other functions associated with tracking pressure levels, HU levels, location and other properties of tanks or other containers during transportation.

The pressure and calibration sensors described can take a variety of forms. Pressure sensors can take a variety of forms and the teachings disclosed herein are not meant to be limited to a particular type of sensor. Piezoresistive strain gauges, capacitive, electromagnetic, piezoelectric, optical, resonant, thermal, diaphragm, and other types of pressure sensors can be used. In some embodiments a temperature sensor may be desired as well.

The tank or container can take a variety of forms and shapes. The teachings disclosed herein, can be used with tanks of various shapes and materials. The teachings can also be applied to tanks that carry a variety of liquids and vapors. In some embodiments the liquid may be water and the vapor may be air. But other embodiments can comprise other materials and substances.

In some embodiments, the local ions of the pressure and calibration sensors within the tank may need to be saved in software that monitors the tank. The type of liquid and type of vapor within the tank may also need to be saved or set ahead of time so that the calculations tor pressure and/or fluid level ore correct.

A power supply may be connected to the fill level sensors and other devices disclosed herein. In some embodiments there will be a battery pack to provide power. Solar panels can also be used to provide power. In embodiments involving tracks, the vehicle's power may be connected to power any devices connected to a tank. A variety of power sources are configurable for the teachings disclosed herein.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. (canceled)

2. (canceled)

3. (canceled)

4. (canceled)

5. (canceled)

6. (canceled)

7. A tank fill level sensor for fluid tanks which directly hold at least one liquid comprising:
a processor;
a pressure sensor communicatively connected to the processor, the pressure sensor being located inside a rigid tank near a bottom of the rigid tank, the pressure sensor being adapted to be immersed in at least one liquid inside the rigid tank;
an elongated tube extending vertically from the pressure sensor;
a calibration sensor communicatively connected to the processor, the calibration sensor having housing comprising an inlet near a top of the rigid tank, the housing further comprising an output, the output extending outside of the rigid tank and operable to provide pressure measurements to the processor, and wherein the housing has a bottom wall, an upper wall extending upwardly from the bottom wall, and a side member extending laterally from the upper wall and through the tank, and wherein the elongated tube mates with the bottom wall, the inlet is disposed in the bottom wall, and the output exits the tank through the side member.

8. The tank till level of sensor of claim 7 wherein the housing comprises a plug at the inlet to prevent liquid from entering the housing.

9. The tank fill level sensor of claim 7 further comprising a user interface communicatively connected to the processor.

10. The tank fill level sensor of claim 7 further comprising a radio interface communicatively connected to the processor.

11. The tank fill level sensor of claim 7 further comprising a display communicatively connected to the processor.

12. (canceled)

13. (canceled)

14. (canceled)

15. (canceled)

16. (canceled)

17. (canceled)

18. (canceled)

19. (canceled)

20. (canceled)
